(19) United States
(12) Patent Application Publication
(10) Pub. No.: US 2009/0192999 A1
(43) Pub. Date: Jul. 30, 2009

(54) SEARCH SERVICE PROVIDING SYSTEM AND SEARCH SERVICE PROVIDING METHOD

(76) Inventor: Honggang WANG, Kanagawa (JP)

Correspondence Address: FROMMER LAWRENCE & HAUG LLP, 745 FIFTH AVENUE, NEW YORK, NY, 10151, US

(21) Appl. No.: 12/361,166

(22) Filed: Jan. 28, 2009

(30) Foreign Application Priority Data
Jan. 30, 2008 (JP) 2008-019640

(51) Int. Cl. G06F 17/30

(52) U.S. Cl. 707/3; 707/10; 707/E17.014; 707/E17.032

(57) ABSTRACT

A search service providing system provides, on an overlay network configured such that at least one node is assigned on a hash space by a distributed hash table technique, a search service for searching at least one resource shared on the overlay network. The node includes: an information collecting unit that collects the resource; a resource database in which the resource collected by the information collecting unit is stored; and a search service providing unit that when a search request for the resource shared on the overlay network is received from a node other than an own node, searches the content of the resource stored in the resource database and outputs a result of the search to the node which has requested the search.

### CROSS REFERENCES TO RELATED APPLICATIONS

The present invention contains subject matter related to Japanese Patent Application JP 2008-019640 filed in the Japanese Patent Office on Jan. 30, 2008, the entire contents of which being incorporated herein by reference.

### BACKGROUND OF THE INVENTION

1. Field of the Invention

The present invention relates to a search service providing system and a search service providing method and in particular, to a search service providing system built on an overlay network and a providing method thereof.

2. Description of the Related Art

In recent years, a connection configuration called peer-to-peer (hereinafter, referred to as ‘P2P’) allowing all nodes (pure nodes) connected to a network to access each other has been drawing attention instead of a client-server connection configuration. Resources, such as document files and telephone book lists, collectively stored in a server in a client-server system are distributed and stored in respective nodes in a system using P2P. Therefore, a mechanism in which the respective nodes cooperate to transmit information on a resource storage location is realized.

As a technique of searching the resource storage location, for example, a distributed hash table (hereinafter, referred to as a ‘DHT’) is known. In the DHT, IDs of nodes or data (resources) stored on a network is managed by hash values obtained by hashing the IDs or data (resources). A hash value is always the same if original data to which a hash function is applied is the same and a hash function used is the same, but the hash value becomes a completely different value if the original data is only slightly different. For this reason, in the DHT, a hash value is used as an identifier for identifying data uniquely.

In the DHT, when a resource is stored on a network, a hash value of the resource is first calculated. Then, in a node having a hash value closest to the calculated hash value, a set of the hash value generated from the resource and the entity of the resource (or a resource storage location (local file path) in a storage device of the node) is registered as a table (hash table). Therefore, if the contents of data stored are different, locations where data is stored are also distributed on the network.

When searching a resource, a hash value of a resource to be searched is calculated and the search is performed using the hash value as a key. In the DHT, all nodes that form a network include routing tables in which a root to a neighboring node is recorded in advance, and the search is performed on the basis of the routing table.

In case of desiring to search a resource registered in a node on a network, a hash value of the resource is first calculated and then a search request is made to a node, which has a hash value closest to the hash value of the resource, among routing tables within its own node. If the node which has received the search request does not have the resource, the node which has received the search request makes a search request to a node, which has a hash value closest to the hash value of the resource, among routing tables within its own node.

The search range becomes narrow by repeating such operation and finally, it becomes possible to reach the storage location of the resource to be acquired eventually. If information on the storage location of the resource to search is known, the entity of a resource can be acquired on the basis of the information. That is, on the overlay network built using a DHT technique, it becomes possible to access the entity of resources without thinking of where the entity of resources exists.

JP-A-2007-53662 discloses an overlay network built using a distributed hash table technique.

### SUMMARY OF THE INVENTION

In the case of searching a certain resource in the overlay network built using the DHT technique, the search is performed using a hash value obtained by hashing the resource as a key as described above.

An example of an overlay network built using the DHT technique is shown in FIG. 13. The overlay network shown in FIG. 13 is configured to include six nodes of nodes N11 to N16, and a document file is stored as resources on the overlay network.

For example, when a user at the node N14 stores a document file S1 with a file name ‘RN1’ on the overlay network, processing for calculating a hash value by hashing ‘RN1’ is first performed. Then, the document file S1 is stored in the node having a hash value close to a calculated hash value ‘RK1’. In FIG. 13, it is assumed that the node having a hash value closest to ‘RK1’, which is a hash value of ‘RN1’, is the node N11. Therefore, the document file S1 with the file name ‘RN1’ is stored in the node N11.

When a user at the node N13 who does not know the storage location of the document file S1 stored as described above searches the document file S1, processing for calculating a hash value of the file name ‘RN1’ of the document file S1 is first performed. Since the hash value of ‘RN1’ is ‘RK1’, an acquisition request of the document file S1 is then transmitted to the node N11 having a hash value closest to ‘RK1’. In addition, the document file S1 is transmitted from the node N11 to the node N13.

However, in such a structure, it is difficult to search a resource storage location unless a user knows the name of a resource (document file in FIG. 13) to search. In addition, even if the user knows only a part of the file name, it is difficult to obtain the hash value ‘RK1’ which is a key for searching the resource storage location. Accordingly, it is difficult to acquire the resource even if the user knows such information.

That is, in the case of the overlay network built using the DHT, there was a problem that ‘partial match search’ using a part of a value (in FIG. 13, a file name of a document file) of an original resource for which a hash value is generated, a keyword included in the resource, and the like could not be performed.

In view of the above, it is desirable to realize partial match search on an overlay network built using the DHT.

According to an embodiment of the present invention, there is provided a search service providing system that provides, on an overlay network configured such that at least one node is assigned on a hash space by a distributed hash table technique, a search service for searching at least one resource shared on the overlay network. The node includes an information collecting unit that collects the resource and a resource database in which the resource collected by the information collecting unit is stored. In addition, the search service providing system includes a search service providing unit that when a search request for the resource shared on the overlay network is received from a node other than its own node, searches the content of the resource stored in the resource database and outputs a result of the search to the node which has requested the search.

Therefore, using information on resources stored in the resource database, a resource that matches a search request can be extracted by the search service providing unit.

According to the embodiment of the present invention, since the search service providing unit can extract a resource that matches a search request using information on resources stored in the resource database, partial match search using a part of a name of the resource or a part of data that forms the resource can be performed.

### BRIEF DESCRIPTION OF THE DRAWINGS

FIG. 1 is an explanatory view illustrating an example of the configuration of a search service providing system according to an embodiment of the present invention;

FIG. 2 is an explanatory view illustrating an example of the configuration of a global service table in the embodiment of the present invention;

FIG. 3 is a flow chart illustrating an example of processing in a service providing node in the embodiment of the present invention;

FIG. 4 is a flow chart illustrating an example of processing in a service using node in the embodiment of the present invention;

FIG. 5 is an explanatory view illustrating an example of the configuration of an overlay network in the embodiment of the present invention;

FIGS. 6A to 6C are explanatory views illustrating examples of the configuration of a telephone book in the embodiment of the present invention, in which FIG. 6A shows an example of a telephone book of Alice, FIG. 6B shows an example of a telephone book of Bob, and FIG. 6C shows an example of a telephone book of Abe;

FIGS. 7A to 7C are explanatory views illustrating examples of the configuration of a resource table in the embodiment of the present invention, in which FIG. 7A shows an example of a resource table of Alice, FIG. 7B shows an example of a resource table of Bob, and FIG. 7C shows an example of a resource table of Abe;

FIG. 8 is a flow chart illustrating an example of processing of an information collecting unit in the embodiment of the present invention;

FIG. 9 is an explanatory view illustrating an example of the configuration of a telephone book database in the embodiment of the present invention;

FIG. 10 is a flow chart illustrating an example of processing of a search service providing unit in the embodiment of the present invention;

FIG. 11 is an explanatory view illustrating an example of a search result of the search service providing unit in the embodiment of the present invention;

FIG. 12 is an explanatory view illustrating an example of a search result of the search service providing unit in the embodiment of the present invention; and

FIG. 13 is an explanatory view illustrating an example of the construction of a known overlay network.

### DESCRIPTION OF THE PREFERRED EMBODIMENTS

Hereinafter, an embodiment of the present invention will be described with reference to the accompanying drawings. A search service providing system according to the embodiment of the present invention is applied to an overlay network configured to include a plurality of information terminals. In this example, the overlay network is built in the form of pure P2P (Peer To Peer) configured to include only peer nodes.

A DHT is used to build the overlay network, and Chord is used as the algorithm. In addition, the algorithm of a DHT is not limited to Chord and other algorithm, such as CAN, Pastry, and Tapestry, may also be used.

In this example, a telephone book search service is exemplified as a service provided by a search service providing system. In addition, the telephone book search service is regarded as one of the global services (hereinafter, simply referred to as a service) provided on the overlay network. The global service is a service available in all nodes included in the overlay network and is a service requested to be always available while the overlay network exists.

Information required to access the global service is written in a table, which is called a global service table, in each node. In each node, the global service is used by accessing a desired global service on the basis of the information written in the global service table. Details of the global service and the global service table will be described later.

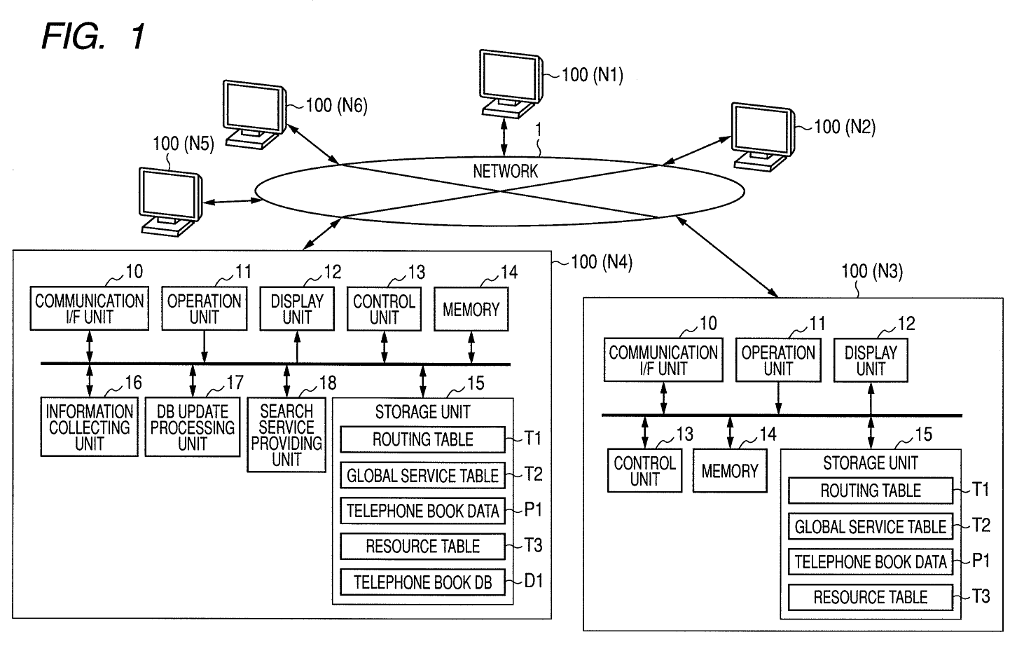

FIG. 1 shows an example of the configuration of a search service providing system. In FIG. 1, a plurality of PCs (personal computers) 100 as information terminals are connected to each other through a network 1. Each PC 100 shown in FIG. 1 is also a node that forms an overlay network. Accordingly, in FIG. 1, the six PCs 100 connected to the network 1 are also displayed as nodes N1 to N6. Also in the following description, the PC 100 is referred to as a node Nn (n is an integer) in explaining a function of the PC 100 as a node. In FIG. 1, the node N4 is anode on a side providing a search service, and the nodes N1 to N3, N5, and N6 are nodes on a side using the search service.

In FIG. 1, each PC 100 has a communication I/F unit 10, an operation unit 11, a display unit 12, a control unit 13, a memory 14, and a storage unit 15.

The communication I/F unit 10 is a unit for interface with the network 1 and controls transmission/reception of data to/from the other PCs 100 on the network 1. The operation unit 11 is formed by a keyboard, a mouse, and the like. The operation unit 11 receives an operation input from a user and outputs an operation signal corresponding to the operation input contents to the control unit 13. For example, when the user uses the search service, the operation unit 11 outputs to the control unit 13 a search keyword input by the user.

The display unit 12 is a display device, such as an LCD (liquid crystal display), and a GUI (graphical user interface) used in a search service is displayed. The control unit 13 is formed by, for example, a CPU (central processing unit) and controls each unit of the PC 100. The memory 14 configured to include a ROM (read only memory), a RAM (random access memory), and the like is connected to the control unit 13. A program required for control is stored in the memory 14. The control unit 13 reads and executes a program stored in the memory 14.

The storage unit 15 is configured to include a memory card, a hard disk, and the like. Telephone book data P1 (hereinafter, simply referred to as a telephone book P1) that a user of the PC 100 uses, a resource table T3 showing information (including a resource name, a resource key, a resource entity, a resource type, and the like) on a resource, which is stored in a corresponding node, among resources stored on a DHT network, and the like are stored in the storage unit 15. Details of the configuration of a resource table T3 will be described later. In addition, a routing table T1 and a global service table T2 are stored beforehand in the storage unit 15.

The routing table T1 is a table in which an access root to a neighboring node is recorded and includes ‘m’ rows, for example. At an i-th row of the table with the m rows, information on a node located ‘2̂(i−1)’ in the clockwise direction from its own node is written.

For example, at the first row of the routing table T1, information on anode located ‘2̂(1−1)=1’ from the own node, that is, a node located at (adjacent to) the first place from the own node in the clockwise rotation is written. That is, in all nodes included in the overlay network, at least information on right-hand neighboring nodes of the own node can be seen. For example, when ‘m’ is set to 4, information on four nodes located 1, 2, 4, and 8 before from the own node is written in the routing table T1.

Since each node has such a routing table T1, a search request can be sequentially transmitted to the nodes on the basis of information of the routing table T1 of each node even if each node has only information on nodes located 1, 2, 4, and 8 before from the node, for example. This makes a search range gradually narrow, and it is possible to reach target data eventually.

The global service table T2 is a table which describes information on all global services provided on the overlay network.

The node N4 shown in FIG. 1 is a node that provides a search service. In addition to the units described above, the node N4 includes an information collecting unit 16 that acquires the telephone book data P1 stored in each PC 100, a database update processing unit 17 (hereinafter, referred to as a DB update processing unit 17) that builds or updates a telephone book database D1 using the telephone book data P1 collected in the information collecting unit 16, and a search service providing unit 18 that provides an interface for search services to a search service using node.

The telephone book database D1 (hereinafter, referred to as a telephone book DBD1) as a resource database is stored in the storage unit 15 as a local file and is also stored on the overlay network as a service record data file which will be described later.

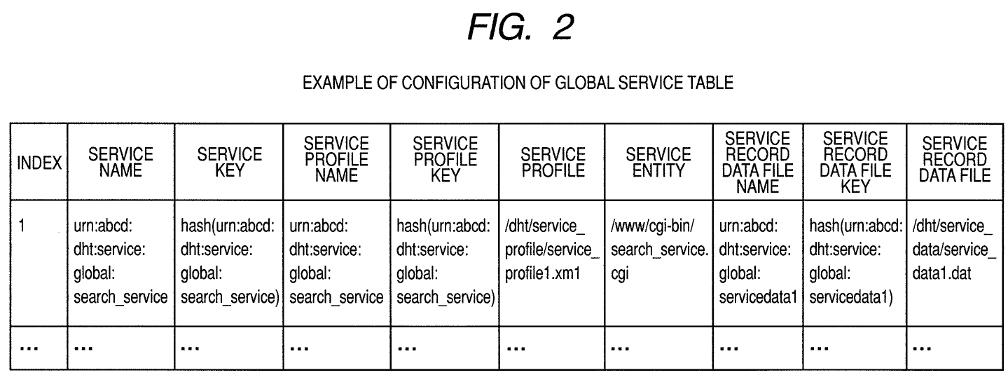

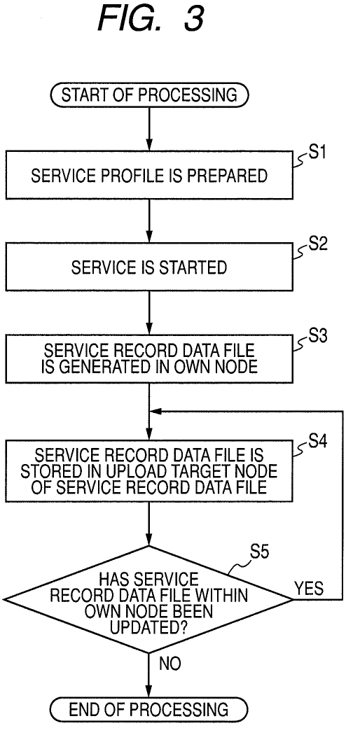

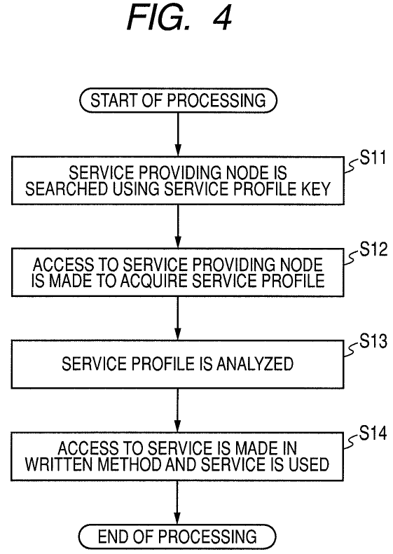

Next, details of the global service which is the requisite for realizing a search service providing system in this example will be described. The configuration of the global service table T2 will be first described with reference to FIG. 2, and then the processing flow in providing a global service and the processing flow in using a global service will be described with reference to FIGS. 3 and 4. Thereafter, the search service providing system in this example will be described.

In the present invention, a global service is defined to have the following four elements.
Service name
Service entity
Service profile
Service record data file

The service name is a name of a service provided on the overlay network and is expressed by URI (uniform resource identifier) or the like on the basis of a predetermined naming scheme. For example, a telephone book search service in this example is expressed like urn:abcdabcd:dht:product:service:global:search_service.

The service entity is an excecutable program and is able to set the start or stop of a service dynamically.

The service profile is a content in a file format in which end point information (including an IP address and a URL) for accessing the service or an API (application programming interface) is written. The service profile is a file that can be configured according to an environment of each node, and the content changes with each node.

For example, when the format of a service profile is like Service-EndPoint=http://host[:port]/path/service, even in the case of service profiles to the same telephone book search service, the service profiles are differently described like http://192.168.0.1/cgi-bin/service1.cgi for the node N1 having an IP address of 192.168.0.1 and http://192.168.1.1:8080/service/service1.cgi for the node N2 having an IP address of 192.168.1.1. The service profile and the service entity are stored in the storage unit 15 (refer to FIG. 1) of each node.

The service record data file is a file, in which data to be recorded and stored is written, generated by execution of a service. In this example, the telephone book DBD1 corresponds to the service record data file. The service record data file is dynamically exported or imported by the service entity.

An example of the configuration of the global service table T2 is shown in FIG. 2. The global service table T2 is configured to include an index, a service name, a service key, a service profile name, a service profile key, a service profile, a service entity, a service record data file name, a service record data file key, and a service record data file.

The index is given corresponding to the number of items of a global service table in the row direction thereof, and numeric values of 1 to n are input. The number of items of the global service table in the row direction increases or decreases according to the number of global services. Since the service name is the same as described above, an explanation thereof will be omitted. The service key is a hash value obtained by hashing the service name and is acquired by hash(service name). In FIG. 2, since a service name is ‘urn:abcd:dht:service:global:search_service’, a service key becomes ‘hash(urn:abcd:dht:service:global:search_service)’.

The service profile name is the same name as the service name. Although the service profile key is a hash value obtained by hashing the service profile name, the service profile key and the service key have the same value since the service profile name and the service name are equal.

A path to the entity of the service profile described above is written in the service profile. Since the service profile is stored in the storage unit 15 (refer to FIG. 1), the path in the storage unit 15 is written in the service profile. In the example shown in FIG. 2, ‘/dht/service_profile/service_profile1.xml’ is written. The path to the service entity described above is also written in the service entity. In the example shown in FIG. 2, ‘www/cgi-bin/service1.cgi’ is written.

The service record data file name is a name of the service record data file described above and is configured to include a character string, such as an URI, in the same manner as the service name. In the example shown in FIG. 2, ‘urn:abcd:dht:service:global:servicedata1’ is written. Since the service record data file key is a hash value obtained by hashing the service record data file name, the service record data file key becomes hash(urn:abcd:dht:service:global:servicedata1). In the service record data file, a path to the entity of the service record data file is written.

In addition, the service key, the service profile key, and the service record data file key may be calculated on the basis of the service name, the service profile name, and the service record data file name. Accordingly, the service key, the service profile key, and the service record data file key may also be acquired by calculation as needed, without providing the service key, the service profile key, and the service record data file key beforehand as items.

Even though all the nodes N1 to N6 included in the overlay network hold the same global service table T2, the service is supplied only to the specific node. The specific node is a node with a shortest distance from the node ID and the service key. In this example, the node is set as a service provider. In FIG. 1, the node N4 corresponds thereto. In addition, the service provider is assumed to satisfy the following conditions.

Having a service entity and executing the service entity

Providing service profile

Creating and updating data required for a service record data file and uploading newest data on the overlay network.

That is, although all the nodes on the overlay network have the service entity, only the node which becomes the service provider executes the service entity. Therefore, only a service profile that the service provider holds is effective as a service profile that describes a method of access to a service being executed.

FIG. 3 is a flow chart illustrating an example of service providing processing performed by a node assigned to a service provider. The node assigned to the service provider first prepares a service profile within its own node (step S1) and then starts service providing by starting the service entity (program) stored in the storage unit 15 (step S2). Then, a service record data file is generated within the own node (step S3). After generating the service record data file, a target node to which the service record data file is to be uploaded is found out and the service record data file is stored in the node (step S4). In addition, the service record data file may also be uploaded to its neighboring nodes simultaneously as well as the upload target node.

Finding of the upload target node and storage of a file to the object node in step S4 are performed by using, for example, an expression of put (key, content). That is, by executing the expression of put (service record data file key, service record data file), a node mapped to the service record data file key is found out and the service record data file is stored in the target node.

After storing the service record data file, it is determined whether or not the service record data file within its own node has been updated (step S5). When it is determined that the update has not been performed, no processing is performed. When it is determined that the update has been performed, the processing returns to step S4 to store the updated file in the update target node. In addition, processing for storing the service record data file within the own node in the update target node is assumed to be performed whenever the service record data file within the own node is updated.

Since different names are given to the service name and the service record data file name, hash values generated from the different names (data) are necessarily different values. Accordingly, by performing such processing, a provider node of the service and a storage node of the service record data file are distributed and stored on the overlay network.

Next, an example of processing performed in a node on a side using a service will be described with reference to the flow chart shown in FIG. 4. First, in the node on the side using the service, a service provider node is searched by using a service profile key written in the global service table T2 of its own node (step S11). Search of the service provider node is performed, for example, using the expression of Node=lookup(key). A node mapped to the service profile key can be acquired by substituting the service profile key into the portion of key.

After finding out the service provider node, access to the service provider node is made on the basis of the routing table T1 of the own node to thereby acquire a service profile that the service provider node has (step S12). Then, the service profile is analyzed (step S13), and access to the service is made using a method written in the service profile in order to use the service (step S14).

Next, examples of the specific configuration and processing of the search service providing system, which is able to perform partial match search, according to the present embodiment will be described.

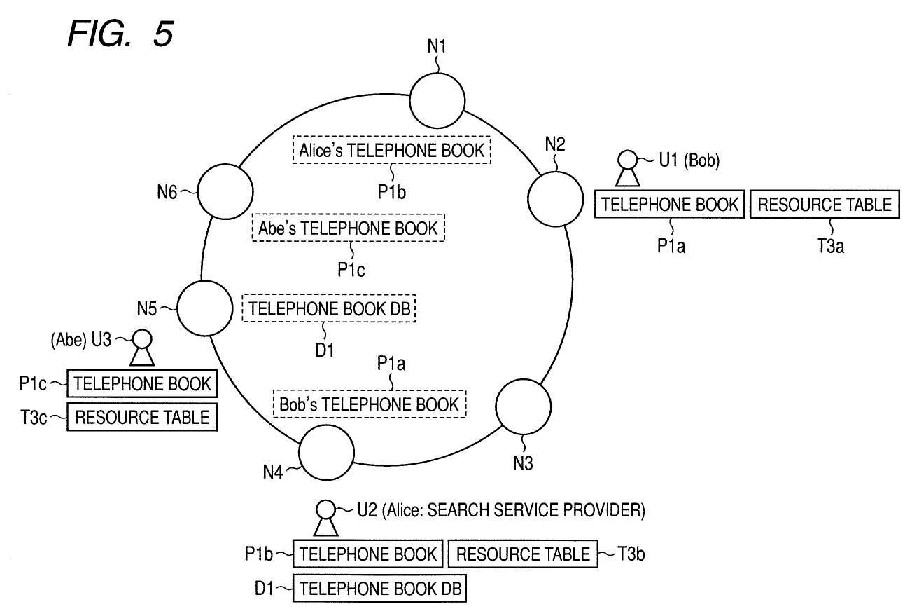

FIG. 5 is a view illustrating a state where the nodes N1 to N6 shown in FIG. 1 are disposed in a hash space. In this example, a case in which Chord algorithm is used is mentioned as an example. The hash space is expressed in a circular form, and the nodes N1 to N6 are disposed such that the node ID becomes large in the clockwise direction.

In FIG. 5, Bob logs in the node N2 as a user U1, Alice logs in the node N4 as a user U2, and Abe logs in the node N5 as a user U3. In each node, a telephone book P1 and the resource table T3 are stored in the storage unit 15 (refer to FIG. 1) and the telephone book P1 is also stored on the overlay network.

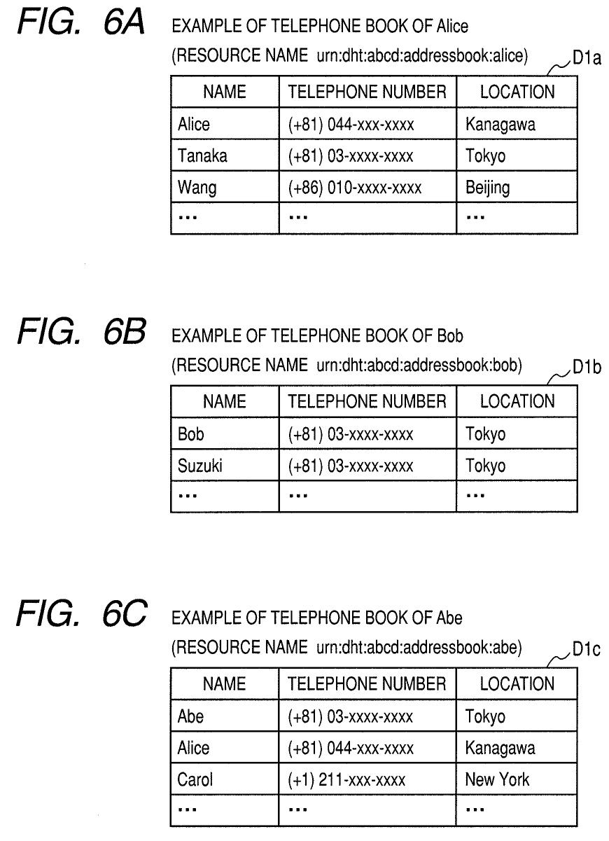

Specifically, a telephone book P1a of Bob (user U1) is stored in the node N4, a telephone book P1b of Alice (user U2) is stored in the node N1, and a telephone book P1c of Abe (user U3) is stored in the node N6. The telephone book P1 is assumed to be formed as lists shown in FIGS. 6A to 6C, for example. FIG. 6A shows an example of the telephone book P1a of Alice, FIG. 6B shows an example of the telephone book P1b of Bob, and FIG. 6C shows an example of the telephone book P1c of Abe.

In FIGS. 6A to 6C, each of the telephone directories P1a to P1c is configured to include a ‘name’, a ‘telephone number’, and a ‘location’. A user name, such as ‘Alice’ or ‘Tanaka’, is described in a column of the ‘name’, a telephone number is written in a column of the ‘telephone number’, and a name of a city in which each user written in the telephone book is located is written in a column of the ‘location’ like ‘Kanagawa’ or ‘Tokyo’. On first rows of the telephone directories P1a to P1c, information on their own telephone numbers and locations are written.

In the telephone book P1a of Alice shown in FIG. 6A, a telephone number of Tanaka located in ‘Tokyo’ and a telephone number of Wang located in ‘Beijing’ are written in addition to information on the telephone number and location of Alice. Other users' information written in the telephone book P1a of Alice is not shown in FIG. 6A. Also in FIGS. 6B and 6C, only some users' information of the information recorded in the telephone book P1 is shown.

In the telephone book P1a of Bob shown in FIG. 6B, a telephone number of Suzuki located in ‘Tokyo’ is written in addition to information on the telephone number and location of Bob. In addition, in the telephone book P1c of Abe shown in FIG. 6C, the telephone number of Alice located in Kanagawa and a telephone number of Carol located in ‘New York’ are written in addition to information on the telephone number and location of Abe.

In addition, resource names for identifying telephone directories are given to the telephone directories P1a to P1c. The resource name of the telephone book P1a of Alice shown in FIG. 6A is ‘urn:dht:abcd:addressbook:alice’, the resource name of the telephone book P1b of Bob shown in FIG. 6B is ‘urn:dht:abcd:addressbook:bob’, and the resource name of the telephone book P1c of Abe shown in FIG. 6C is ‘urn:dht:abcd:addressbook:abe’.

By storing the telephone book P1 configured as described above also on the overlay network, the users of the nodes N1 to N6 can acquire information on telephone directories that other users create. For example, in the case where Bob wants to acquire the telephone book data P1a of Alice, the telephone book P1a can be acquired by calculating a resource key (=hash(urn:dht:abcd:addressbook:alice)) obtained by hashing the resource name of the telephone book of Alice and executing a command of dht_get (resource key) using the resource key.

In this method, however, it is necessary to know beforehand a resource name or resource key of a resource that Alice has. If the resource name or resource key is not known, desired telephone book data cannot be acquired. Moreover, the telephone book is searched using the resource key obtained by hashing the resource name. Accordingly, even if the whole telephone book P1 hit as a search result can be acquired, partial search cannot be performed on data included in the telephone book P1.

For example, search of a telephone number of a user located in ‘Tokyo’ cannot be performed. In addition, it is difficult to meet a demand to search the telephone book P1 that users (Alice and Abe in this example) starting with ‘A’ have.

Therefore, in this example, the search service providing node N4 is configured to provide a search service to each node by acquiring the telephone book data P1 of each node N to build the telephone book database D1 and using the telephone book database D1. In each node N using the search service, the resource table T3 in which a resource name, a resource key, and the like of the telephone book P1 are written is provided as an interface used to meet a telephone book data acquisition request of the search service providing node N4.

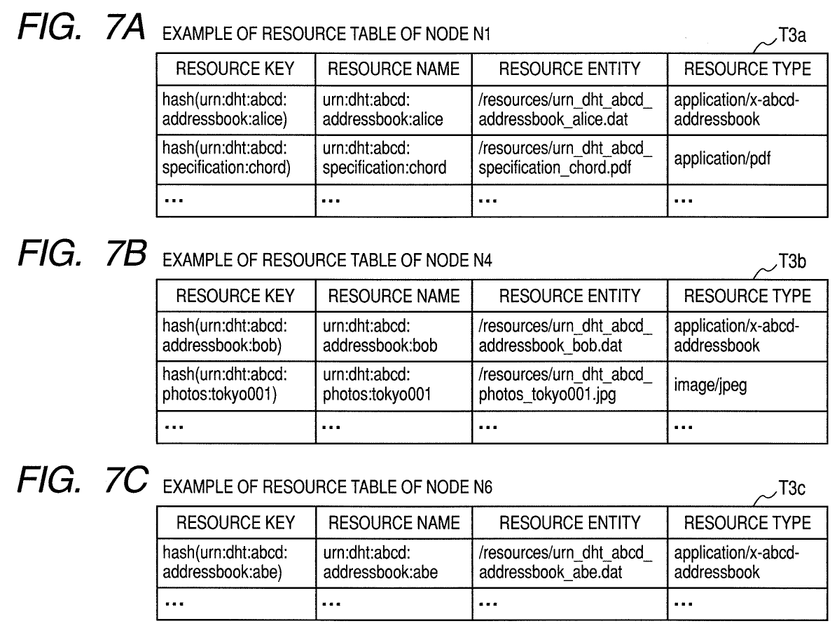

An example of the configuration of the resource table T3 is shown in FIGS. 7A to 7C. FIG. 7A shows a resource table T3a in the node N1, FIG. 7B shows a resource table T3b in the node N4, and FIG. 7C shows a resource table T3c in the node N6. On each resource table T3, it is assumed that not only information on the telephone book D1 but also information on all resources shared on the overlay network is written. Each resource table T3 shown in FIGS. 7A to 7C is configured to include items of a ‘resource key’, a ‘resource name’, a ‘resource entity’, and a ‘resource type’.

In a column of the ‘resource entity’, a path to information on a storage location of the telephone book P1 is written in the case when the resource is the telephone book P1. Specifically, a path to a storage device of a node in which the telephone book P1 is stored is written. In a column of the ‘resource type’, the type of applications, such as a ‘telephone book’ and an ‘authentication service’, is indicated in the case when the resource is an application, and the type or extension of data is written as a resource type in the case when the resource is data, such as a still image or a dynamic image.

An example of the configuration of the resource table T3a stored in the node N1 is shown in FIG. 7A. In the first row, a value obtained by hashing ‘urn:dht:abcd:addressbook:alice’ which is a resource name of the telephone book P1a of Alice is written in a column of a resource key, a resource name is written in a column of a resource name, a path to a storage location of software that accesses the telephone book P1a is written in a column of a resource entity like ‘/resources/urn_dht_abcd_addressbook_alice.dat’, and ‘application/x-abcd-addressbook’ indicating that a resource is the telephone book P1 is written in a column of a resource type.

In a row (second row) below the first row, information on other resources that Alice has is written. Since this resource is assumed to be a specification, a hash key obtained by hashing a resource name ‘urn:dht:abcd: specification: chord’ is written in the column of the ‘resource key’, a resource name is written in the column of the ‘resource name’, storage location information (‘/resources/urn_dht_abcd_specification_chord.pdf’) on the resource entity is written in the column of the ‘resource entity’, and ‘application/pdf’ indicating that the resource is a specification and the extension is pdf is written in the column of the ‘resource type’.

An example of the configuration of the resource table T3b stored in the node N4 is shown in FIG. 7B. In the resource table T3b, information on the telephone book P1b that Bob has is written in the first row and information on a still image file, which Bob owns and whose extension is JPEG, is written in the second row.

That is, in the first row, a hash key obtained by hashing a resource name ‘urn:dht:abcd:addressbook:bob’ of the telephone book P1b of Bob is written in the column of the ‘resource key’, a resource name is written in the column of the ‘resource name’, storage location information (‘/resources/urn_dht_abcd_addressbook_bob.dat’) on the resource entity is written in the column of the ‘resource entity’, and ‘application/x-abcd-addressbook’ is written in the column of the ‘resource type’. In the second row, a hash key obtained by hashing a resource name ‘urn:dht:abcd:photos:tokyo001’ is written in the column of the ‘resource key’, a resource name is written in the column of the ‘resource name’, storage location information (‘/resources/urn_dht_abcd_photos_tokyo001.jpg’) on the resource entity is written in the column of the ‘resource entity’, and ‘image/jpeg’ is written in the column of the ‘resource type’.

An example of the configuration of the resource table T3c stored in the node N6 is shown in FIG. 7C. A value obtained by hashing a resource name ‘urn:dht:abcd:addressbook:alice’ which is a resource name of the telephone book P1c of Bob is written in the column of the ‘resource key’, a resource name is written in the column of the ‘resource name’, storage location information (‘/resources/urn_dht_abcd_addressbook_abe.dat’) on the resource entity is written in the column of the ‘resource entity’, and ‘application/x-abcd-addressbook’ indicating that the resource is the telephone book P1 is written in the column of the ‘resource type’.

In the search service providing node N4, the telephone book P1 stored in each node N is acquired on the basis of the information on the resource table T3 configured as described above. In the search service providing unit 18 of the search service providing node N4, the flow in the service providing node shown in FIG. 3 is first executed in advance of such processing. That is, search interface (for example, a function or a parameter) or endpoint information for accessing a search service is first written in a service profile (step S1), and then the search service is started (step S2).

Then, a service record data file is generated within the own node (step S3). Here, the telephone book DBD1 (refer to FIG. 1) is assumed to be generated as a service record data file. When the service record data file is uploaded to an upload target node (step S4), it is then determined whether or not the content of the service record file within the own node has been updated (step S5). Update of the content of the service record file within the own node becomes the timing at which information is collected by the information collecting unit 16 and the information is written in the telephone book DBD1 by the DB update processing unit 17.

When it is determined that the content of the service record file within the own node has not been updated, the search service providing unit 18 performs no processing. When it is determined that the content of the service record file within the own node has been updated, the search service providing unit 18 returns to step S4 to perform processing. In addition, although other processing for providing a search service is performed in the search service providing unit 18, the content of the processing will be described later.

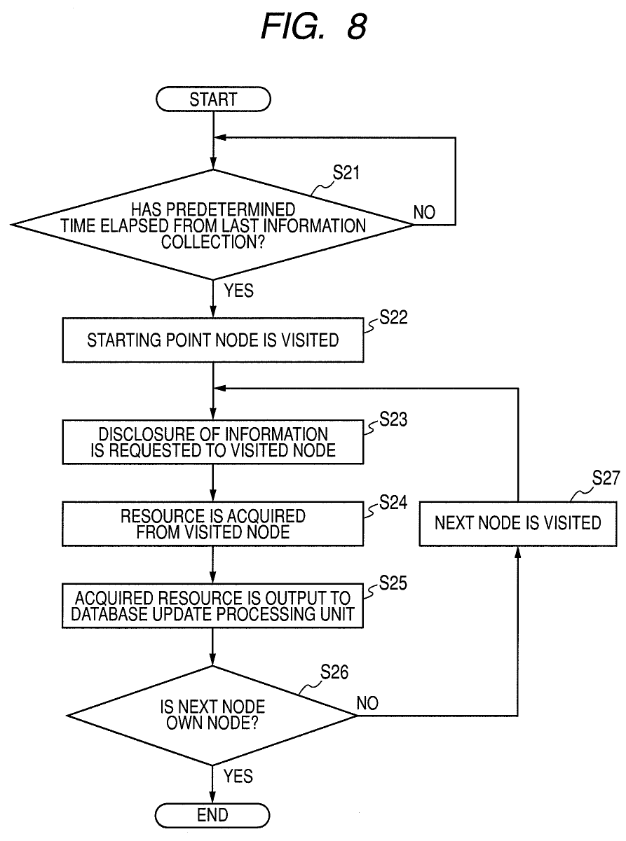

Next, an example of processing of the information collecting unit 16 (refer to FIG. 1) of the search service providing node N4 will be described with reference to the flow chart shown in FIG. 8.

Referring to FIG. 8, first, the information collecting unit 16 determines whether or not a predetermined time has elapsed from the last information collection time (step S21). Since information collection of the information collecting unit 16 is performed every predetermined time, determination of step S21 is repeated until the predetermined period elapses. When it is determined that the predetermined time has elapsed from the last information collection time, a starting point node as an information collecting location is visited (step S22).

The starting point node referred herein is an own node. Then, the information collecting unit 16 requests disclosure of information to the own node N4 (step S23). The disclosure request in this case may be performed in any kind of method. For example, a GET method of HTTP (HyperText Transfer Protocol) may be used. Disclosure of the information on the resource table T3 is first requested, and the information collecting unit 16 acquires a desired resource (telephone book P1 in this example) on the basis of the information written in the resource table T3.

The information collecting unit 16 acquires the telephone book P1 using a command of get-resource (resource type), for example (step S24). In the resource table T3b of the node N4, as shown in FIG. 7B, ‘application/x-abcd-addressbook’ is written in the resource type of a telephone book. Accordingly, the information collecting unit 16 acquires the telephone book P1b in the node N4 by using the command of get_resource (application/x-abcd-addressbook).

Then, the resource (telephone book P1) acquired in this way is output to the DB update processing unit 17 (step S25), and a next node of the visited node (own node in this case) determines whether or not the next node is the own node (step S26). It can be determined whether or not the next node of the visited node is the own node by referring to the routing table T1 stored in the visited node.

In a first row of the routing table T1, a node adjacent to the node in the clockwise direction in the hash space is written. That is, this node becomes a ‘next node’ with the visited node as a starting point. According to the example of the configuration of the overlay network shown in FIG. 5, a next node of the node N4 which is the own node becomes the node N5 adjacent to the left, which is different from the node N4. Accordingly, the information collecting unit 16 visits the node N5 which is the next node (step S27). Then, processing of step S23 and processing of steps subsequent thereto are performed.

Such processing is repeated such that the telephone book P1 is acquired in all nodes other than the own node. Then, in step S26, it is determined whether or not the next node of the visited node is the own node. When it is determined that the next node of the visited node is the own node, the processing is ended.

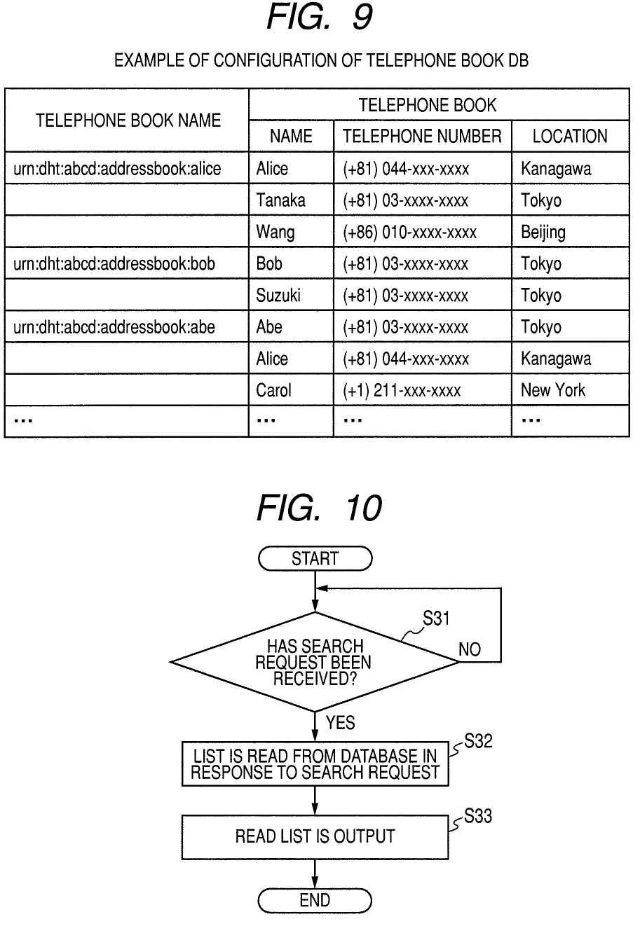

The information collecting unit 16 outputs the acquired telephone book P1 to the DB update processing unit 17. The DB update processing unit 17 performs processing for writing the telephone book P1 output from the information collecting unit 16 into the telephone book DBD1. An example of the configuration of the telephone book DBD1 is shown in FIG. 9. The telephone book DBD1 shown in FIG. 9 is configured to include items of a ‘telephone book name’ and a ‘telephone book’. The ‘telephone book’ is configured to include items of a ‘name’, a ‘telephone number’, and a ‘location’. In this example, a format of the telephone book P1 stored in each node N is not changed. However, items recorded in the telephone book DBD1 may be selected as necessary.

In a column of the ‘telephone book name’, a resource name of a telephone book in each node N is written. In FIG. 9, ‘urn:dht:abcd:addressbook:alice’ which is a resource name of the telephone book P1a of Alice, ‘urn:dht:abcd:addressbook:bob’ which is a resource name of the telephone book P1b of Bob, and ‘urn:dht:abcd:addressbook:abe’ which is a resource name of the telephone book P1c of Abe are written in the column of the ‘telephone book name’.

In addition, in the item of the ‘telephone book’ when the ‘telephone book name’ is ‘urn:dht:abcd:addressbook:alice’, telephone number information and location information of ‘Alice’, ‘Tanaka’, and ‘Wang’ written in the telephone book P1a of Alice are written. Similarly, telephone number information and location information of ‘Bob’ and ‘Suzuki’ written in the telephone book P1b of Bob are written in the item of the ‘telephone book’ when the ‘telephone book name’ is ‘urn:dht:abcd:addressbook:bob’, and telephone number information and location information of ‘Abe’, ‘Alice’, and ‘Carol’ written in the telephone book P1c of Abe are written in the item of the ‘telephone book’ when the ‘telephone book name’ is ‘urn:dht:abcd:addressbook:abe’.

Using the telephone book DBD1 generated as described above, the search service providing unit 18 provides the search service. An example of processing of the search service providing unit 18 is shown in the flow chart of FIG. 10.

Referring to FIG. 10, first, the search service providing unit 18 determines whether or not the search service providing unit 18 has received a search request from the node N on a side using a search service (step S31). The search service providing unit 18 performs no processing while the search request is not received. When the search service providing unit 18 has received the search request, the search service providing unit 18 performs search of the telephone book DBD1, in response to the search request, using as a key a category of a resource or a keyword designated in the search request. Then, processing for reading a corresponding list is performed (step S32). The read list is transmitted to the search request node (step S33).

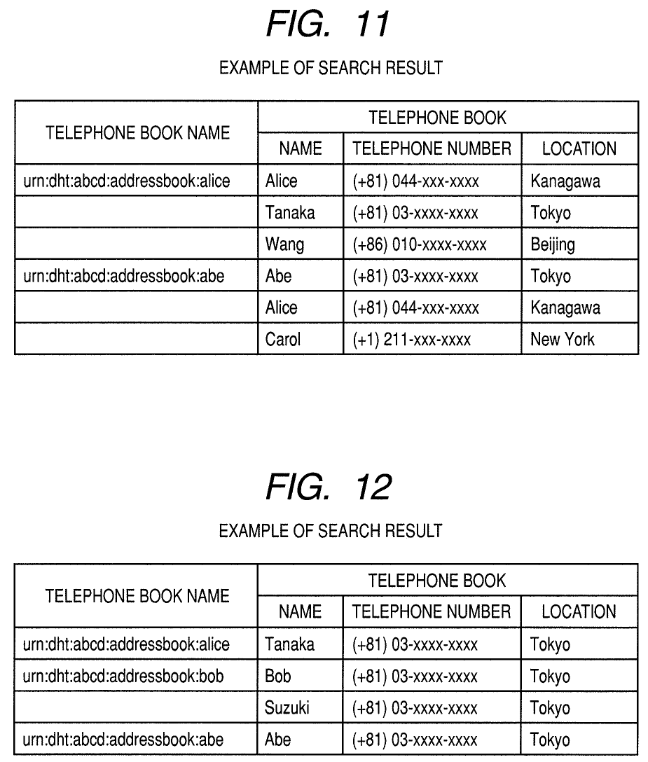

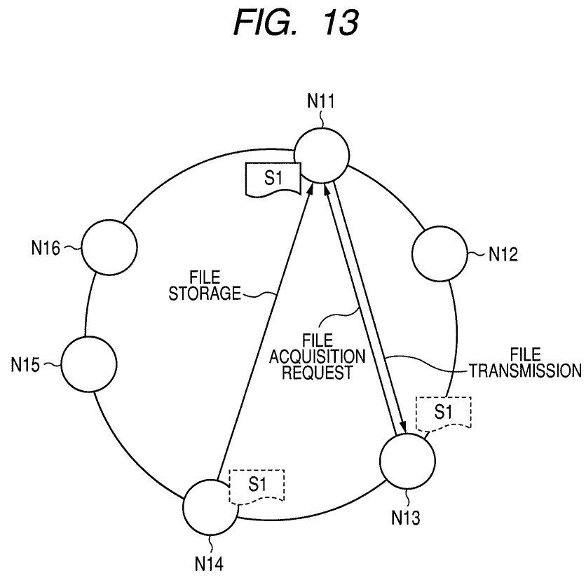

Examples of lists that the search service providing unit 18 outputs as search results are shown in FIGS. 11 and 12. A search result when a search request for ‘telephone directories that persons with names starting with ‘A’ own’ is received is shown in FIG. 11. Since database to be searched is the telephone book DBD1 shown in FIG. 9, telephone directories of ‘Alice’ and ‘Abe’ which are names starting with ‘A’ are extracted from the telephone book DBD1. Therefore, in the list shown in FIG. 11, information on the telephone book of ‘Alice’ and information on the telephone book of ‘Abe’ are written.

That is, as information of a ‘telephone book name’ of ‘urn:dht:abcd:addressbook:alice’, not only telephone number information and location information on Alice who is an owner of the telephone book but also telephone number information on ‘Tanaka’ located in Tokyo and telephone number information on ‘Wang’ located in Beijing are written. That is, as information of a ‘telephone book name’ of ‘urn:dht:abcd:addressbook:abe’, not only telephone number information and location information on Abe who is an owner of the telephone book P1c but also telephone number information on ‘Alice’ located in Kanagawa and telephone number information on ‘Carol’ located in New York are written.

A search result when a search request for ‘telephone number information on persons whose locations are Tokyo’ is received is shown in FIG. 12. Therefore, telephone number information on ‘Tanaka’ located in Tokyo which is recorded in the telephone book of Alice, telephone number information on ‘Bob’ and ‘Suzuki’ located in Tokyo which is recorded in the telephone book of ‘Bob’, and telephone number information on ‘Abe’ located in Tokyo which is recorded in the telephone book of ‘Abe’ are extracted from the list shown in FIG. 12.

According to the embodiment described above, since a search request can be made to the telephone book DBD1 in which information on the telephone book P1 in each node is stored, any element may be a search keyword as long as the element is information included in the telephone book DBD1. That is, even if information, such as a resource name of a resource to be acquired or a resource key obtained by hashing the resource name, is not known beforehand, the desired telephone book P1 can be acquired by using any of the information included in the telephone book P1. That is, the full text of the telephone book P1 that each node owns can be searched.

In addition, since the search can be performed by using, as a key, a name of the owner of the telephone book P1 or information on the ‘location’ included in the telephone book P1, only information corresponding to the search request can be extracted. That is, it becomes possible not only to acquire the entire resource stored in a specific node but also to extract and acquire only data, which includes an element designated by the user, among data included in the resource.

In addition, since information on the overlay network is collected periodically by the information collecting unit 16, the content of the telephone book DBD1 in which the information is stored is always the newest content. This enables the user to search the newest information.

Moreover, in the above embodiment, a case where the type of resource treated in the search service is the telephone book P1 has been exemplified. However, resources treated in the search service are not limited thereto, and application to any resource may also be made as long as the resource is a resource shared on the overlay network. For example, it may be said that file information, such as a still image or a dynamic image and a document file, information on a user or organization of each node included in the overlay network, and the like are target resources for the search service.

In this case, when the type of resource is specified by the user, types of the ‘resource type’ in the resource table T3 are restricted, and only resource information of the type designated by the user is extracted. That is, the user can acquire only a resource, which belongs to a specific category, among various resources shared on the overlay network.

In this case, the user can search information on all resources shared on the overlay network by simply inputting a specific keyword regarding a resource to be acquired without particularly designating a category of the resource.

Furthermore, in this case, when the information collecting unit 16 is made to collect a service profile that each node N owns to thereby generate a database of the service profile, an interface through which the service provided on the overlay network can be searched may be provided to the user. That is, a system such as so-called UDDI (Universal Description, Discovery and Integration), which is a Web service search system, can be realized by using the search service in this example.

In addition, although an example where the search system is applied to the overlay network built by pure P2P has been described in the above embodiment, the search system may also be applied to a form of hybrid type P2P including a server that collectively manages addresses of resources or super node type P2P in which a specific node with high throughput spontaneously manages addresses of resources.

In the case where the search system is applied to the overlay network built by super node type P2P, the super node continuously operates 365 days and 24 hours to provide a global service, such as a search service. Accordingly, a database in which information collected by the information collecting unit 16 is stored does not need to be stored as a service record data file in the overlay network. That is, the database in which resource information is recorded may be stored only in the super node which is a service providing node.

In addition, although a case where each node included in the overlay network is a PC has been described as an example in the above embodiment, the node may also be other devices, such as a terminal used in a video conference system or a portable information terminal.

It should be understood by those skilled in the art that various modifications, combinations, sub-combinations and alterations may occur depending on design requirements and other factors insofar as they are within the scope of the appended claims or the equivalents thereof.

What is claimed is:

1. A search service providing system that provides, on an overlay network configured such that at least one node is assigned on a hash space by a distributed hash table technique, a search service for searching at least one resource shared on the overlay network,
wherein the node includes: p1 an information collecting unit that collects the resource;
a resource database in which the resource collected by the information collecting unit is stored; and
a search service providing unit that when a search request for the resource shared on the overlay network is received from a node other than an own node, searches the content of the resource stored in the resource database and outputs a result of the search to the node which has requested the search.

2. The search service providing system according to claim 1,
wherein when a search request using a specific element included in the resource is received from a node other than the own node, the search service providing unit extracts the resource having the specific element from the resource database and outputs the extracted resource to the node which has requested the search.

3. The search service providing system according to claim 2,
wherein when a search request using a specific element included in the resource is received from a node other than the own node, the search service providing unit extracts only information of a predetermined location, which corresponds to the specific element, of the resource having the specific element from the resource database and outputs the extracted information to the node which has requested the search.

4. The search service providing system according to claim 3,
wherein a node having the resource has a resource table in which a resource key obtained by hashing the resource and resource type information indicating the type of the resource are written.

5. The search service providing system according to claim 4,
wherein when a search request made with the specified type of the resource is received from a node other than the own node, the search service providing unit extracts a resource corresponding to the specified type from the resource database on the basis of the resource type information written in the resource table and outputs the extracted resource to the node which has requested the search.

6. The search service providing system according to claim 3,
wherein in a node which provides the search service or other services, a service profile in which a method of accessing the service entity and a name of the service are written.

7. The search service providing system according to claim 6,
wherein the information collecting unit collects the service profile, and
the search service providing unit receives a search request for the service provided on the overlay network and outputs information on the service to a node which has requested the search.

8. A search service providing method of providing, on an overlay network configured such that at least one node is assigned on a hash space by a distributed hash table technique, a search service for searching at least one resource shared on the overlay network, the method comprising the steps of:
collecting the resource;
storing the collected resource; and
searching the content of the stored resource and outputting a result of the search to a node which has requested the search when a search request for the resource shared on the overlay network is received from the node other than an own node.
